(19) United States
(12) Patent Application Publication
(10) Pub. No.: US 2004/0212927 A1
(43) Pub. Date: Oct. 28, 2004

(54) Drive device

(75) Inventors: Harumi Aoishi, Odawara-shi (JP); Akihisa Kusayanagi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/796,054

(22) Filed: Mar. 10, 2004

(30) Foreign Application Priority Data
Mar. 11, 2003 (JP) 065212/2003

(51) Int. Cl. G11B 17/04; G11B 23/03

(52) U.S. Cl. 360/133

(57) ABSTRACT

To improve the reliability of an engagement and ejection mechanism of a drive device having an accommodating portion for accommodating therein a magnetic disk.

A drive device with a cartridge engagement and ejection mechanism comprises: a cam having a sliding groove containing an engaging corner for locking a driving axis and an disengaging corner positioned adjacent to the engaging corner; a latching member having a latching portion to be engaged with a notch of a magnetic disk cartridge, and a driving shaft which slides within the sliding groove; and a resilient member for urging the latching member in the direction ejecting the magnetic disk cartridge, wherein the disengaging corner is selected to satisfy the relationship d≦r≦3 d, where “r” is a curvature of the disengaging corner and “d” is a radius of the driving shaft.

### BACKGROUND OF THE INVENTION

1. Field of the Invention

The present invention relates to drive devices for magnetically writing and reading information to and from a magnetic disk cartridge received therein.

2. Description of the Related Art

Conventionally, mobile equipment such as digital cameras, etc., use very small magnetic disk cartridges called “clik!™” as recording media.

This magnetic disk cartridge comprises a flat housing (width 50 mm, depth 55 mm, thickness 1.95 mm) constituted by a resin frame including a push portion, and upper and lower shells formed of thin metal sheets; and a 1.8 inch (45.7 mm) diameter magnetic disk having a 40 MB storage capacity and rotatably accommodated in the flat housing.

This housing of the magnetic disk cartridge has a wedge-shaped opening to allow a magnetic head of a drive device to access the surface of the magnetic disk. A rotary shutter is used to open and close this opening. This rotary shutter is spring-loaded towards its closing direction by means of a small-diameter elongate coil spring.

In the left end surface of the housing, a notch to be engaged with a latching portion formed within the drive device is provided to ensure positioning of the cartridge in the drive device. Meanwhile, in the right end surface of the housing of the drawing, a small window for exposing a shutter lock member towards the outside is provided to keep the rotary shutter locked in the closed position.

The lower shell of the housing includes a circular opening through which a rotary spindle of the drive device couples with the center core of the magnetic disk, and an arcuate groove concentric with the rotary shutter. The rotary shutter has a shutter knob fixedly provided thereon which protrudes from the aforementioned arcuate groove. The shutter knob travels along this arcuate groove to allow opening and closing of the rotary shutter.

The drive device suitable for the aforementioned magnetic disk cartridge is a TYPE II PC card type drive device having a width of 53 mm, a depth of 85 mm, and a thickness of 5 mm, comprising a slot into which the disk cartridge is inserted, a spindle motor having a spindle for magnetically attracting a center core of a magnetic disk, a head actuator, a swing arm, and a head suspension supported by the swing arm. A magnetic head which accesses the surface of the magnetic disk during rotation thereof for recording and/or reproducing information is disposed at a distal end of the head suspension.

The drive device further comprises a push-push type cartridge engagement and ejection mechanism including a heart-shaped cam as described in Japanese Unexamined Patent Publication Nos. 02(1990)-295011 and 2001-085089, and an input/output interface for interfacing to electronic equipment such as a digital camera, personal computer and the like to which the drive device is mounted.

On the back and right side of the slot of the drive device, an engaging wall, which extends laterally in a direction substantially perpendicular to the insertion direction of the magnetic disk cartridge, is formed as shutter opening means, and further an unlocking member is provided which unlocks the rotary shutter from its closed and locked position upon insertion of the magnetic disk cartridge.

When the magnetic disk cartridge is inserted into the slot of the drive device, the unlocking member first pushes the shutter lock member and then the shutter knob engages with the engaging wall under this state. Therefore, as the magnetic disk cartridge is inserted, the shutter knob is slid along the engaging wall, during which the rotary shutter moves to its open position while compressing its coil spring. At the same time, the latching portion of the drive device body engages with the notch of the magnetic disk cartridge, and thus the magnetic disk cartridge is mounted in position within the drive device.

To eject the magnetic disk cartridge, on the other hand, it is necessary to press the push portion of the magnetic disk cartridges such that the cartridge engagement and ejection mechanism pushes the magnetic disk cartridge out. At this time, the initial velocity for ejection is ensured by the compressed coil spring. The rotary shutter is rotated to its closed position by the urging force of the aforementioned coil spring as the magnetic disk cartridge is pulled out, and finally locked by the shutter lock member.

Specifically, the aforementioned engagement and ejection mechanism comprises (1) a cam having an annular groove constituted by (a) a going section which extends substantially in the direction of the ejection and introduction of the magnetic disk cartridge, (b) an engaging section whose starting position is positioned adjacent to the end position of the going section, and (c) a returning section whose starting position is positioned adjacent to the end position of the engaging section and whose end position is positioned adjacent to the starting position of the going section; (2) a latching member having a latching portion to be engaged with a notch of the magnetic disk cartridge, and a driving shaft which slides within the sliding groove; and (3) a resilient member for urging the latching member in the direction to eject the magnetic disk cartridge. When the magnetic disk cartridge is inserted into the slot of the drive device, the driving shaft, which is provided on the engaging member so as to be engaged with the magnetic disk cartridge, slides within the sliding groove and then is engaged at the engaging corner formed in the engaging section, whereby the magnetic disk cartridge is loaded in place within the drive device. On the other hand, when the push portion of the magnetic disk cartridges is pressed to eject the magnetic disk cartridge, the driving shaft rides across the unlocking corner and accordingly is unlocked, whereby the magnetic disk cartridge is ejected. In conventional drive devices, the disengaging corner forms a generally right angle. Because of this, there is a possibility that the driving shaft cannot ride across the disengaging corner when the disk cartridge is ejected, which causes the magnetic disk cartridge to be ejected improperly.

### SUMMARY OF THE INVENTION

In view of the foregoing problem, an object of the present invention is to provide a drive device which includes an accommodating portion for accommodating therein a disk cartridge, wherein the reliability of a cartridge engagement and ejection mechanism thereof is improved.

In accordance with the present invention, a drive device having an accommodating portion for accommodating therein a magnetic disk cartridge comprises: a thermoplastic resin cam having an annular groove, the annular groove being constituted by a going section which extends substantially in the direction of the ejection and introduction of the magnetic disk cartridge, an engaging section whose starting position is positioned adjacent to the end position of the going section, and a returning section whose starting position is positioned adjacent to the end position of the engaging section and whose end position is positioned adjacent to the starting position of the going section; a latching member having a latching portion to be engaged with a notch of the magnetic disk cartridge and a driving shaft which slides within the annular groove; and a resilient member for urging the latching member in the direction ejecting the magnetic disk cartridge. The engaging section comprises an engaging corner for engaging the driving shaft and a disengaging corner positioned adjacent the engaging corner. The disengaging corner is selected to satisfy the relationship d≦r≦3 d, where “r” is a curvature of the disengaging corner and “d” is a radius of the driving shaft.

The thermoplastic resins that may be used include “Vectra A980 and A430” (products of Polyplastics Co., Ltd.) and a polyoxymethylene resin containing potassium titanate whiskers, for example, “Duracon KT-20” (a product of Polyplastics Co., Ltd.).

The material of the aforementioned driving shaft may preferably be that made by vapor depositing or vacuum plating gold-palladium on the surface of a steel base.

The aforementioned disengaging corner is more preferably selected to satisfy the relationship 1.3 d≦r≦2.6 d.

If the curvature of a turn corner at a joint between the engaging section and the returning section is expressed by “r′”, the curvature is preferably selected to satisfy the relationship r′≧r. As used herein, the term “the curvature of a turn corner at a joint between the engaging section and a returning section” refers to the corner formed inside the annular sliding groove.

It is also preferable to provide metal plates respectively on the face of the engaging section containing the starting position of the engaging corner, and on the face of the engaging section containing the end position of the engaging corner and the starting position of the disengaging corner. This enables suppression of undesirable physical deformation of the engaging and disengaging corners as a result of wear.

If the distance in the engaging section from the face containing the starting position of the engaging corner to the starting position of the disengaging corner is expressed by “f”, this distance is preferably selected to satisfy the relationship d≦f≦3 d, and more preferably 1.5 d≦f≦2.5 d.

In the drive device of the present invention, the curvature “r” of the disengaging corner adjacent to the engaging corner for engaging the driving shaft within the sliding groove is optimally selected so as to satisfy the relationship d≦r≦3 d. This prevents the possibility that the magnetic disk cartridge is not properly inserted therein because the driving shaft rides across the disengaging corner when the magnetic disk cartridge is inserted. This structure also prevents improper ejection of the magnetic disk cartridge due to the driving shaft not riding across the disengaging corner when the disk cartridge is ejected, thereby improving the reliability of the engagement and ejection mechanism of the drive device.

Selecting the curvature “r” of the disengaging corner to satisfy the relationship 1.3 d≦r≦2.6 d enables further improvements in the reliability of the engagement and ejection mechanism.

In addition, selecting the curvature “r′” of the turn corner at a joint between the engaging section and the returning section to satisfy the relationship r′≧r enables still further improvements in the reliability of the engagement and ejection mechanism.

Further, selecting the distance “f” in the engaging section from the face containing the starting position of the engaging corner to the starting position of the disengaging corner to satisfy the relationship d≦f≦3 d, and more preferably 1.5 d≦f≦2.5 d enables still further improvements in the reliability of the engagement and ejection mechanism.

### BRIEF DESCRIPTION OF THE DRAWINGS

FIG. 1A, FIG. 1B, and FIG. 1C respectively are a plan view, a right side view, and a bottom view showing a magnetic disk cartridge removably received within a PC card type drive device according to the present invention;

FIG. 2 is a plan view showing a drive device body of the PC card type drive device of the invention;

FIG. 3 is an enlarged view showing a sliding groove of the PC card type drive device;

FIG. 4 is an enlarged view showing the periphery of the engaging corner of the sliding groove; and

FIG. 5 is an enlarged view showing the periphery of a variation of the engaging corner of the sliding groove.

### DESCRIPTION OF THE PREFERRED EMBODIMENTS

Hereinafter, a preferred embodiment of the present invention will be described in detail with reference to the attached drawings.

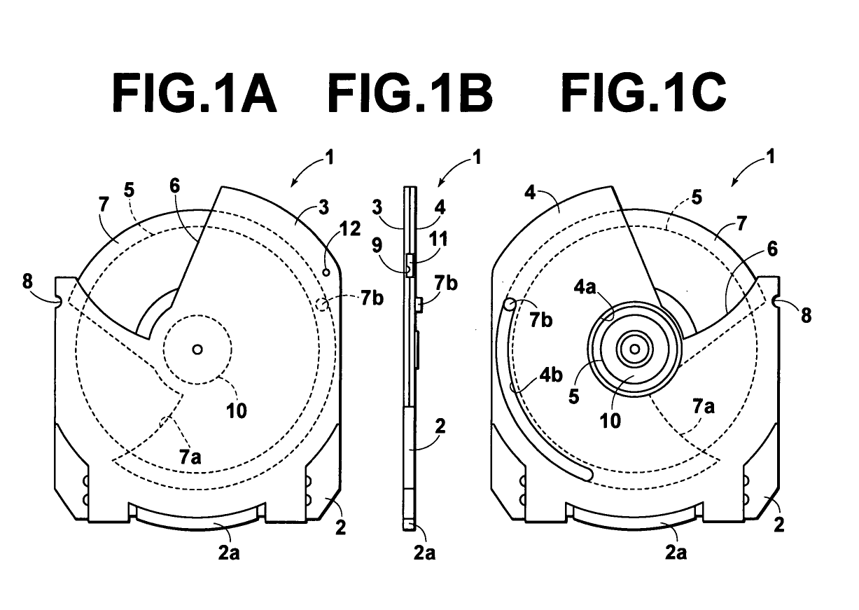

FIGS. 1A to 1C illustrate a very small magnetic disk cartridge called “clik!™” which is removably received within a PC card type drive device in a push-and-pull manner. FIG. 1A is a plan-view, FIG. 1B is a right side view, and FIG. 1C is a bottom view of the magnetic disk cartridge.

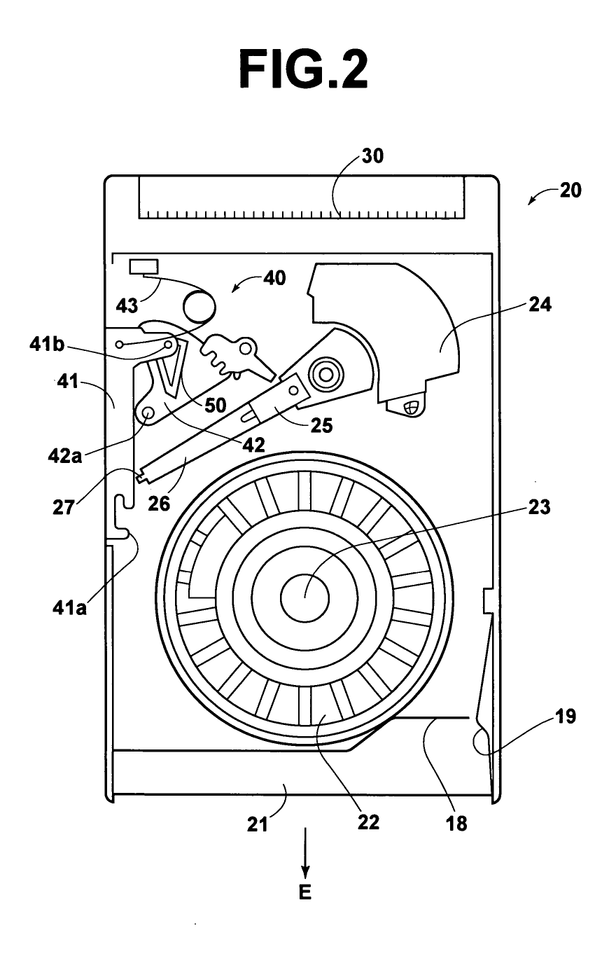

FIG. 2 is a plan view showing a body of the PC card type drive device according to the invention. This drive device comprises a drive device body 20 (shown), and a metal upper lid (not shown) which is put on the body 20 and has substantially the same overhead contour as that of the body 20.

A magnetic disk cartridge 1 shown in FIG. 1 comprises a flat housing (width 50 mm, depth 55 mm, thickness 1.95 mm) constituted by a resin frame 2 including a push portion 2a, and upper and lower shells 3 and 4 formed of thin metal sheets; and a 1.8 inch (45.7 mm) diameter magnetic disk 5 with a 40 MB storage capacity, which is rotatably accommodated within the housing.

The aforementioned housing has a wedge-shaped opening 6 to allow a magnetic head 27 of the drive device body 20 shown in FIG. 2 to access the surface of the magnetic disk 5, and a rotary shutter 7 used to open and close this opening 6. The rotary shutter 7 is spring-loaded towards its closing direction (in the counter-clockwise direction in FIG. 1A) by means of a small-diameter elongate coil spring (not shown) provided within the housing.

In the left end surface of the housing, a notch 8 to be engaged with a latching portion 29a of a latching member 29 formed within the drive device body 20 is provided to ensure positioning of the cartridge in the drive device body 20. Meanwhile, in the right end surface of the housing, a small window 9 for exposing a shutter lock member 11 towards the exterior is provided to keep the rotary shutter 7 locked in the closed position. FIGS. 1A to 1C show the state that the rotary shutter 7 is locked in the closed position.

The lower shell 4 of the housing includes a circular opening 4a through which a rotary spindle 23 of the drive device 20 couples with a center core 10 of the magnetic disk 5, and an arcuate groove 4b concentric with the rotary shutter 7. The rotary shutter 7 has a shutter knob 7b provided immovably thereon which projects from the aforementioned arcuate groove 4b and travels along this arcuate groove 4b, thereby opening and closing the rotary shutter 7.

The shutter lock member 11 for locking the rotary shutter 7 in the closed position is rotatably mounted to the shaft 12 provided in the housing and is spring-loaded in the direction for locking the rotary shutter 7. When the magnetic disk cartridge 1 is inserted into the drive device body 20, an unlocking member 19 provided on the drive device body 20 pushes the shutter lock member 11 through the small window 9. This will cause the lock member 11 to be slightly rotated in the unlocking direction and thus the rotary shutter 7 is unlocked.

The drive device body 20 in FIG. 2 is a TYPE II PC card type drive device, which is 53 mm wide, 85 mm deep, and 5 mm thick, and shown with a metal upper lid being removed. The drive device body 20 comprises a slot 21 into which the disk cartridge 1 is inserted, a spindle motor 22 having a spindle 23 which serves to magnetically attract the center core 10 of the magnetic disk 5, a head actuator 24, a swing arm 25, and a head suspension 26 supported by the swing arm 25. The head suspension 26 has at the tip thereof a magnetic head 27 which accesses the surface of the magnetic disk 5 during rotation to record and/or reproduce information.

The drive device body 20 further comprises a push-push type cartridge engagement and ejection mechanism 40, and an input/output interface 30 for interfacing to electronic equipment such as a digital camera, personal computer and the like to which the drive device body 20 is mounted.

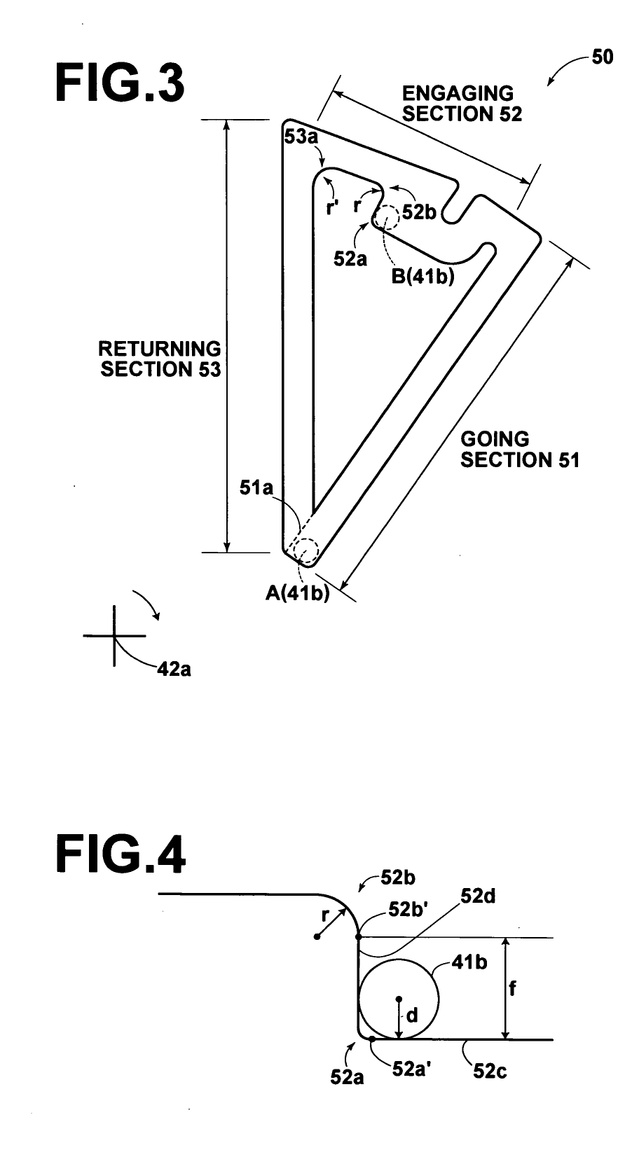

Hereinafter, a description will be made in detail on the cartridge engagement and ejection mechanism 40 with reference to the drawings. FIG. 3 is an enlarged view of a sliding groove 50 provided in a cam 42 of the cartridge engagement and ejection mechanism 40.

The cartridge engagement and ejection mechanism 40 comprises a thermoplastic resin cam having an annular groove 50; a latching member 41 having a latching portion 41a to be engaged with a notch 8 of the magnetic disk cartridge 1 and a driving shaft 41b which slides within the sliding groove 50; and a resilient member 43 for urging the latching member 41 in the direction ejecting the magnetic disk cartridge 1 (the direction indicated by arrow E in FIG. 2). The driving shaft 41b is made by vapor depositing gold-palladium on the surface of a steel base. The cam 42 is held rotatably around the shaft 42a and urged clockwise as seen in FIG. 2.

The annular groove 50 is constituted by a going section 51 which extends substantially in the direction of the ejection and introduction of the magnetic disk cartridge 1, an engaging section 52 whose starting position is positioned adjacent to the end position of the going section 51, and a returning section 53 whose starting position is positioned adjacent to the end position of the engaging section 52 and whose end position is positioned adjacent to the starting position of the going section 51.

In order to prevent the driving shaft 41b from sliding to the returning section 53 side during insertion of the magnetic disk cartridge 1, a height difference 51a is provided between the going section 51 and the returning section 53.

FIG. 4 shows an enlarged view of the periphery of an engaging corner 52a in the engaging section 52. The engaging corner 52a for engaging the driving shaft 42b and a disengaging corner 52b positioned adjacent to the engaging corner 52a are provided in the engaging section 52. The curvature “r” of the disengaging corner 52b is selected to satisfy the relationship d≦r≦3 d, where “d” is the radius of the driving shaft 41b.

Further, the distance f in the engaging section 52 from the face 52c containing the starting position 52a′ of the engaging corner 52a to the starting position 52b′ of the disengaging corner 52b is selected to satisfy the relationship d≦f≦3 d.

Still further, the curvature “r′” of a turn corner53a at a joint between the engaging section 52 and the returning section 53 is selected to be greater than the curvature “r” of the engaging corner 52a.

The driving shaft 41b is located in the initial position A before insertion of the magnetic disk cartridge 1. Once the magnetic disk cartridge 1 is inserted, the driving shaft 41b slides from the going section 51 to the engaging section 52 and is locked at a locking position B by the engaging corner 52a. On the other hand, when the magnetic disk cartridge 1 is pressed to eject the magnetic disk cartridge 1, the driving shaft 41b rides across the disengaging corner 52b while sliding from the engaging section 52 to the returning section 53, and returns to the initial position A.

In this arrangement, the configuration of the sliding groove 50 is optimized by selecting the curvature “r” of the disengaging corner 52b to satisfy the relationship d≦r≦3 d, the distance “f” in the engaging section 52 from the face 53c containing the starting position 52a′ of the engaging corner 52a to the starting position 52b′ of the disengaging corner 52b to satisfy the relationship d≦f≦3 d, and the curvature “r′” of the turning corner 53a at a junction between the engaging section 52 and the returning section 53 to be greater than the curvature “r” of the disengaging corner 52b. This prevents the magnetic disk cartridge 1 from not being properly inserted in the drive device due to the driving shaft 41b riding across the disengaging corner 52b during insertion of the magnetic disk cartridge 1. This also prevents the magnetic disk cartridge 1 from not being properly ejected therefrom due to the driving shaft 41b not being able to ride across the disengaging corner 52b when the disk cartridge 1 is ejected, thereby improving the reliability of the engagement and ejection mechanism 40 of the drive device.

The reliability of the engagement and ejection mechanism can be further improved by selecting the curvature “r” of the disengaging corner 52b to satisfy the relationship 1.3 d≦r≦2.6 d, and the distance “f” in the engaging section 52 from the face 52c containing the starting position 52a′ of the engaging corner 52a to the starting position 52b′ of the disengaging corner 52b to satisfy the relationship 1.5 d≦f≦2.5 d.

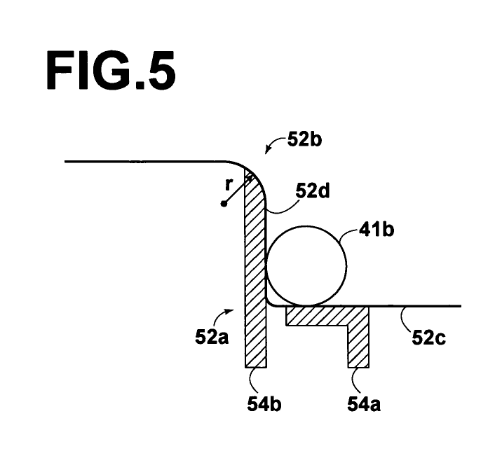

Further, undesirable physical deformation of the engaging and disengaging corners as a result of wear can be avoided by increasing the strength of the engaging corner 52a and disengaging corner 52b by placing metal plates 54a and 54b respectively on the face 52c containing the starting position 52a′ of the engaging corner 52a, and on the face 52d containing the end position of the engaging corner 52a and the starting position 52b′ of the disengaging corner 52b as shown in FIG. 5.

Preferably, these metal plates 54a, 54b are made of the same material as that of the driving shaft 41b and have a thickness in the range of about 0.1 to 0.3 mm,

If a conduction mechanism is connected to the metal plates 54a, 54b, the metal plates 54a, 54b are spaced apart from one another and provided with electricity through the metal driving shaft 41b when the driving shaft 41b is located at the locking position B, these metal plates 54a, 54b may be used as means for detecting insertion of a magnetic disk cartridge 1.

On the back and right side of the slot 21 of the drive device body 20, an engaging wall 18, which extends laterally in a direction substantially perpendicular to the insertion direction of the magnetic disk cartridge 1, is formed as shutter opening means, and further an unlocking member 19 is provided which releases the rotary shutter 7 from its closed and locked position upon insertion of the magnetic disk cartridge 1.

When the magnetic disk cartridge 1 is inserted into the slot 21 of the drive device, the unlocking member 19 first presses the shutter lock member 11 and then the shutter knob 7b engages with the engaging wall 18 under this state. Accordingly, as the magnetic disk cartridge 1 is inserted, the shutter knob 7b is slid along the engaging wall 18, during which the rotary shutter 7 moves to its open position while compressing its urging coil spring. At the same time, the latching portion 41a of the latching member 41 of the drive device body 20 engages with the notch 8 of the magnetic disk cartridge 1, and the driving shaft 41b provided on the latching member 41 slides within the sliding groove 50 and is locked by the engaging corner 52a formed in the engaging section 52. As a result, the magnetic disk cartridge 1 is held in position within the drive device body 20.

On the other hand, to remove the magnetic disk cartridge 1 from the drive device, an operator presses the push portion 2a of the magnetic disk cartridges 1, whereby the driving shaft 41b rides across the disengaging corner 52b to become a disengaged state. At this time, the initial velocity for ejection is ensured by the compressed coil spring for urging the rotary shutter. The rotary shutter 7 is rotated to its closed position by the urging force of the aforementioned coil spring as the magnetic disk cartridge 1 is pulled out, and then locked by the shutter lock member 11.

What is claimed is:

1. A drive device having an accommodating portion for accommodating therein a magnetic disk cartridge, comprising:
a thermoplastic resin cam having an annular groove, the annular groove being constituted by a going section which extends substantially in the direction of the ejection and introduction of the magnetic disk cartridge, an engaging section whose starting position is positioned adjacent to the end position of the going section, and a returning section whose starting position is positioned adjacent to the end position of the engaging section and whose end position is positioned adjacent to the starting position of the going section;
a latching member having a latching portion to be engaged with a notch of the magnetic disk cartridge, and a driving shaft which slides within the sliding groove; and
a resilient member for urging the latching member in the direction ejecting the magnetic disk cartridge,
wherein the engaging section comprises an engaging corner for engaging the driving shaft and an disengaging corner positioned adjacent the engaging corner, and
wherein the disengaging corner is selected to satisfy the relationship d≦r≦3 d, where “r” is a curvature of the disengaging corner and “d” is a radius of the driving shaft.

2. A drive device according to claim 1, wherein the engaging corner is formed to satisfy the relationship 1.3 d≦r≦2.6 d.

3. A drive device according to claim 1, wherein the curvature “r′” of a turning corner at a joint between the engaging section and the returning section is formed to satisfy the relationship r′≧r.

4. A drive device according to claim 1, wherein metal plates are respectively placed on the face of the engaging section containing the start position of the engaging corner, and on the face of the engaging section containing the end position of the engaging corner and the start position of the disengaging corner.

5. A drive device according to claim 1, wherein a distance “f” in the engaging section from the face containing the starting position of the engaging corner to the starting position of the disengaging corner is selected to satisfy the relationship d≦f≦3 d.

6. A drive device according to claim 5, wherein the distance “f” is selected to satisfy the relationship 1.5 d≦f≦2.5 d.
